(19) United States
(12) Patent Application Publication
(10) Pub. No.: US 2022/0056298 A1
(43) Pub. Date: Feb. 24, 2022

(54) PROCESSING FLUID, SET OF PROCESSING FLUID AND INK, PRINTING METHOD, AND PRINTING APPARATUS

(71) Applicants: Kazuhiko Umemura, Kanagawa (JP); Tomohiro Nakagawa, Kanagawa (JP); Hiroki Hagiwara, Kanagawa (JP); Sei Yamamoto, Tokyo (JP); Masayuki Koyano, Kanagawa (JP); Yuya Hirokawa, Kanagawa (JP); Takuya Saiga, Kanagawa (JP)

(72) Inventors: Kazuhiko Umemura, Kanagawa (JP); Tomohiro Nakagawa, Kanagawa (JP); Hiroki Hagiwara, Kanagawa (JP); Sei Yamamoto, Tokyo (JP); Masayuki Koyano, Kanagawa (JP); Yuya Hirokawa, Kanagawa (JP); Takuya Saiga, Kanagawa (JP)

(73) Assignee: Ricoh Company, Ltd., Tokyo (JP)

(21) Appl. No.: 17/386,239

(22) Filed: Jul. 27, 2021

(30) Foreign Application Priority Data
Aug. 18, 2020 (JP) 2020-137699
Jun. 1, 2021 (JP) 2021-092028

(51) Int. Cl. C09D 11/54; C09D 11/102; C09D 11/107; C09D 11/033; C09D 11/40; C09D 11/38; B41M 5/00

(52) U.S. Cl. CPC C09D 11/54; C09D 11/102; C09D 11/107; B41M 2205/12; C09D 11/40; C09D 11/38; B41M 5/0017; C09D 11/033

(57) ABSTRACT

Provided is a processing fluid including: water; a flocculant; and a urethane resin. A dry film formed of the processing fluid and having an average thickness of 500 micrometers has a tensile strength of 3.5 MPa or greater and a breaking elongation of 80% or greater.

### CROSS-REFERENCE TO RELATED APPLICATIONS

This patent application is based on and claims priority pursuant to 35 U.S.C. § 119(a) to Japanese Patent Application No. 2020-137699, filed on Aug. 18, 2020, and Japanese Patent Application No. 2021-092028, filed on Jun. 1, 2021 in the Japan Patent Office, the entire disclosure of which is hereby incorporated by reference herein.

### BACKGROUND

### Technical Field

The present disclosure relates to a processing fluid, a set of a processing fluid and an ink, a printing method, and a printing apparatus.

### Description of the Related Art

Inkjet recording methods are becoming spread from personal use to office use and commercial and industrial printing fields because inkjet recording methods have simpler processes and easier adaptability to full-color operations, and can form higher-resolution images with simpler device configuration than other recording methods. In the commercial printing field, in addition to plain paper, coated paper such as coat paper and art paper, and polymeric films for soft packaging such as polyethylene terephthalate (PET) films and biaxially stretched (OPP) polypropylene films are used as print media. Moreover, in the commercially printing field, images having a high scratch resistance are demanded because printed matters are used as postcards and product packaging materials such as packages, corrugating materials, and cardboard liners.

### SUMMARY

According to one embodiment of the present disclosure, a processing fluid contains water, a flocculant, and a urethane resin. A dry film formed of the processing fluid and having an average thickness of 500 micrometers has a tensile strength of 3.5 MPa or greater and a breaking elongation of 80% or greater.

### BRIEF DESCRIPTION OF THE DRAWING

Amore complete appreciation of the disclosure and many of the attendant advantages and features thereof can be readily obtained and understood from the following detailed description with reference to the accompanying drawing, wherein:

the drawing is a schematic view illustrating a printing apparatus according to an embodiment of the present disclosure used in a printing method according to an embodiment of the present disclosure.

The accompanying drawing is intended to depict embodiments of the present invention and should not be interpreted to limit the scope thereof. The accompanying drawing is not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

The present disclosure can provide a processing fluid that can provide a printed matter having an excellent drying property, a high scratch resistance, and an ink bleed resistance.

(Processing Fluid)

A processing fluid of the present disclosure contains water, a flocculant, and a urethane resin. A dry film formed of the processing fluid and having an average thickness of 500 micrometers has a tensile strength of 3.5 MPa or greater and a breaking elongation of 80% or greater. The processing fluid preferably contains an organic solvent and a surfactant, and further contains other components as needed. The processing fluid may be referred to as “pre-processing fluid” and “pre-coat liquid”.

According to existing techniques, the urethane resin contained in the processing fluid is not optimized, and a dry film formed of the processing fluid and having an average thickness of 500 micrometers does not satisfy the tensile strength of 3.5 MPa or greater and the breaking elongation of 80% or greater. This leads to a problem that when a solid image is scratched with a dry cotton cloth 50 times or more repeatedly under a load of 400 g, the solid image is scarred to have a degraded image brightness.

In the present disclosure, a processing fluid contains water, a flocculant, and a urethane resin. A dry film formed of the processing fluid and having an average thickness of 500 micrometers has a tensile strength of 3.5 MPa or greater and a breaking elongation of 80% or greater, and preferably has a tensile strength of 3.8 MPa or greater and a breaking elongation of 100% or greater. The upper limit of the tensile strength is preferably 5.0 MPa or less, and the upper limit of the breaking elongation is preferably 200% or less.

When the tensile strength and the breaking elongation of a dry film of the processing fluid are in the numerical ranges described above, the processing fluid itself has a high strength. Therefore, even when a dry film of the processing fluid is scratched 50 times or more repeatedly together with a solid image formed of an ink applied over the surface of the processing fluid with a dry cotton cloth under a load of 400 g, the dry film of the processing fluid has a high scratch resistance of a level at which the dry film is not easily scarred and even an observable scar in the dry film does not influence the image brightness.

The tensile strength and the breaking elongation of the dry film formed of the processing fluid can be measured in the manner described below.

The processing fluid is applied over a polytetrafluoroethylene (PTFE) sheet with a roller, and dried at 40 degrees C. for 12 hours and further dried at 60 degrees C. for 6 hours. Subsequently, the dried film is peeled, to produce a dry film of the processing fluid having an average thickness of 500 micrometers.

The obtained dry film is drawn at a tensile speed of 200 mm/min with a tensile tester (available from Shimadzu Corporation, AUTOGRAPH AGS-5KN) at a measuring temperature of 25 degrees C. The strength and the elongation when the dry film is broken are measured.

<Urethane Resin>

Using a urethane resin as a resin, the processing fluid of the present disclosure can provide a printed matter having a high scratch resistance. This is because the urethane resin has an excellent tensile strength and a great margin against, for example, elongation and shrinkage involved in the packaging use such as cardboard liners.

Preferable properties required of the urethane resin include a tensile strength of 40 MPa or greater and a breaking elongation of 500% or greater but 900% or less. When the tensile strength and the breaking elongation are in the numerical ranges described above, the processing fluid itself has a high strength. Therefore, scratch resistance of not only the processing fluid but also an ink applied over the surface of the processing fluid can be greatly improved. Particularly when the tensile strength of the urethane resin is 40 MPa or greater, a solid image has a high scratch resistance of a level at which the solid image is not easily scarred even when the solid image is scratched 50 times or more repeatedly with a dry cotton cloth under a load of 400 g, and even if the solid image is scarred, the scar is slight and does not influence the image brightness.

The tensile strength and the breaking elongation of the urethane resin can be measured in the manner described below.

A urethane resin emulsion is applied over a polytetrafluoroethylene (PTFE) sheet, and dried at 40 degrees C. for 12 hours and further dried at 60 degrees C. for 6 hours. Subsequently, the urethane resin film is peeled, to produce a urethane resin film having an average thickness of 500 micrometers.

The obtained urethane resin film is drawn at a tensile speed of 200 mm/min with a tensile tester (available from Shimazu Corporation, AUTOGRAPH AGS-5KN) at a measuring temperature of 25 degrees C. The strength and the elongation when the urethane resin film is broken are measured.

It is preferable to use the urethane resin in the form of a resin emulsion obtained by dispersing resin particles in water.

As the urethane resin, a polycarbonate urethane resin is preferable because a preferable viscoelasticity can be easily obtained and an excellent scratch resistance is obtained.

The polycarbonate urethane resin is not particularly limited and may be appropriately selected depending on the intended purpose. An appropriately synthesized product may be used or a commercially available product may be used. Examples of the commercially available product include, but are not limited to, product name: TAKELAC WS-6021, product name: TAKELAC WS-5000, and product name: TAKELAC W-6110 (all available from Mitsui Chemicals, Inc.), and product name: SUPERFLEX 470 and SUPERFLEX 840 (both available from DKS Co., Ltd.). One of these products may be used alone or two or more of these products may be used in combination.

The content of the urethane resin is different depending on the kind of the urethane resin and cannot be determined flatly. However, the content of the urethane resin expressed as a content of a solid component is preferably 5% by mass or greater and more preferably 5% by mass or greater but 20% by mass or less relative to the total amount of the processing fluid.

For example, an acrylic resin and a polycarbonate resin may be used in combination with the urethane resin in the processing fluid of the present disclosure.

The acrylic resin is not particularly limited and may be appropriately selected depending on the intended purpose. Examples of the acrylic resin include, but are not limited to, acrylic silicone resins and styrene-acrylic resins. One of these acrylic resins may be used alone or two or more of these acrylic resins may be used in combination. Among these acrylic resins, styrene-acrylic resins are preferable in terms of scratch resistance and blocking resistance.

The volume average particle diameter of the acrylic resin particles is not particularly limited, may be appropriately selected depending on the intended purpose, and is preferably 10 nm or greater but 1,000 nm or less, more preferably 10 nm or greater but 200 nm or less, and particularly preferably 10 nm or greater but 100 nm or less in terms of obtaining a good fixability and a high image hardness.

The volume average particle diameter can be measured with, for example, a particle size analyzer (NANOTRAC WAVE-UT151, available from MicrotracBEL Corporation).

An appropriately synthesized product may be used or a commercially available product may be used as the acrylic resin depending on the intended purpose. Examples of the commercially available product include, but are not limited to, product name: SYMAC (available from Toagosei Company. Limited), product name: BONCOAT (available from DIC Corporation), and AQUABRID (available from Daicel Corporation).

The mass ratio of the acrylic resin: the urethane resin is preferably from 1:9 through 9:1 and more preferably from 2:8 through 8:2. The mass ratio is adjusted depending on the print medium and use of the printed matter. When the ratio of the urethane resin is the greater, scratch resistance is improved. When the ratio of the acrylic resin is the greater, blocking resistance is improved.

<Flocculant>

The flocculant has a function of coagulating a coloring material contained in an ink, and is preferably a metal salt.

Examples of the metal salt include, but are not limited to, magnesium chloride, magnesium sulfate, magnesium nitrate, magnesium acetate, magnesium bromide, calcium nitrate, calcium acetate, and aluminum chloride, and aluminum nitrate, or anhydrides or hydrates of these metal salts. One of these metal salts may be used alone or two or more of these metal salts may be used in combination. Among these metal salts, magnesium sulfate is particularly preferable in terms of preventing ink bleed.

The content of the metal salt is not particularly limited and may be appropriately adjusted in a manner that a predetermined pigment coagulating effect can be obtained, considering, for example, the kind of the metal salt used. When the content of the metal salt is extremely high, there is a risk that coatability and the drying property of the processing fluid may degrade.

The content of the metal salt serving as a flocculant is preferably 1% by mass or greater but 20% by mass or less and more preferably 2% by mass or greater but 8% by mass or less relative to the total amount of the processing fluid.

<Water>

The water is not particularly limited and may be appropriately selected depending on the intended purpose. Examples of the water include, but are not limited to, pure water such as ion-exchanged water, ultrafiltrated water, reverse osmotic water, and distilled water, and ultrapure water. One of these kinds of water may be used alone or two or more of these kinds of water may be used in combination.

The content of the water in the processing fluid is not particularly limited, and the water needs at least to be contained in an amount enough for the multivalent metal salt not to precipitate during storage at normal temperature.

<Surfactant>

As the surfactant, any selected from silicone-based surfactants, fluorosurfactants, amphoteric surfactants, nonionic surfactants, anionic surfactants, and acetylene glycol surfactants may be used. Among these surfactants, acetylene glycol surfactants are preferable when a print medium is paper or a cardboard liner. Acetylene glycol surfactants have an advantage that they have low permeability into paper and cardboard liners and can keep the resin or the flocculant, which is contained in the processing fluid, remaining above the surface of a print medium.

The silicone-based surfactant has no specific limit and can be suitably selected to suit to a particular application. Of these, preferred are silicone-based surfactants which are not decomposed even in a high pH environment. Specific examples thereof include, but are not limited to, side-chain-modified polydimethylsiloxane, both end-modified polydimethylsiloxane, one-end-modified polydimethylsiloxane, and side-chain-both-end-modified polydimethylsiloxane. A silicone-based surfactant having a polyoxyethylene group or a polyoxyethylene polyoxypropylene group as a modifying group is particularly preferable because such an agent demonstrates good characteristics as an aqueous surfactant. It is possible to use a polyether-modified silicone-based surfactant as the silicone-based surfactant. A specific example thereof is a compound in which a polyalkylene oxide structure is introduced into the side chain of the Si site of dimethyl siloxane.

Specific examples of the fluoro surfactants include, but are not limited to, perfluoroalkyl sulfonic acid compounds, perfluoroalkyl carboxylic acid compounds, perfluoroalkyl phosphoric acid ester compounds, adducts of perfluoroalkyl ethylene oxide, and polyoxyalkylene ether polymer compounds having a perfluoroalkyl ether group in its side chain. These are particularly preferable because they do not foam easily. Specific examples of the perfluoroalkyl sulfonic acid compounds include, but are not limited to, perfluoroalkyl sulfonic acid and salts of perfluoroalkyl sulfonic acid. Specific examples of the perfluoroalkyl carboxylic acid compounds include, but are not limited to, perfluoroalkyl carboxylic acid and salts of perfluoroalkyl carboxylic acid. Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain and salts of polyoxyalkylene ether polymers having a perfluoroalkyl ether group in its side chain. Counter ions of salts in these fluorine-based surfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxy ethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides, etc.

Specific examples of the anionic surfactants include, but are not limited to, polyoxyethylene alkyl ether acetates, dodecyl benzene sulfonates, laurates, and polyoxyethylene alkyl ether sulfates.

These can be used alone or in combination.

The proportion of the surfactant is not particularly limited and can be suitably selected to suit to a particular application. It is preferably from 0.001 to 5 percent by mass and more preferably from 0.05 to 5 percent by mass relative to the total amount of the processing fluid in terms of excellent wettability and discharging stability and improvement on image quality.

<Organic Solvent>

Examples of the organic solvent include, but are not limited to, 1,2-propanediol, 1,2-butanediol, 1,3-butanediol, 2,3-butanediol, 3-methoxy-3-methylbutanol, and 1,2-hexanediol. One of these organic solvents may be used alone or two or more of these organic solvents may be used in combination. Because of a high moisture retaining property, these organic solvents facilitate handling of the processing fluid. Moreover, because of a Hansen solubility parameter (HSP) values close to those of urethane resin emulsions, these organic solvents have a high affinity with urethane resin emulsions and improve dispersion stability of urethane resins.

The processing fluid may further contain any other organic solvents than those described above as the organic solvent.

Any other organic solvents may be appropriately selected depending on the intended purpose so long as the quality of an ink is not spoiled

Examples of water-soluble organic solvents include, but are not limited to, polyvalent alcohols, polyvalent alcohol alkyl ethers, polyvalent alcohol aryl ethers, nitrogen-containing heterocyclic compounds, amides, amines, and sulfur-containing compounds.

Examples of the water-soluble organic solvents include, but are not limited to, polyvalent alcohols such as ethylene glycol, diethylene glycol, 1,4-butanediol, 3-methyl-1,3-butanediol, triethylene glycol, polyethylene glycol, polypropylene glycol, 1,2-pentanediol, 1,3-pentanediol, 1,4-pentanediol, 2,4-pentanediol, 1,5-pentanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butanetriol, 1,2,3-butanetriol, 2,2,4-trimethyl-1,3-pentanediol, and petriol; polyvalent alcohol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyvalent alcohol aryl ethers such as ethylene glycol monophenyl ether, and ethylene glycol monobenzyl ether; nitrogen-containing heterocyclic compounds such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides such as formamide, N-methyl formamide, N,N-dimethyl formamide, 3-methoxy-N,N-dimethyl propionamide, and 3-butoxy-N,N-dimethyl propionamide; amines such as monoethanol amine, diethanol amine, and triethyl amine; sulfur-containing compounds such as dimethyl sulfoxide, sulfolane, and thiodiethanol; and propylene carbonate and ethylene carbonate.

Since the water-soluble organic solvent serves as a humectant and also imparts a good drying property, it is preferable to use an organic solvent having a boiling point of 250 degrees C. or lower.

The content of the organic solvent in the processing fluid is not particularly limited, may be appropriately selected depending on the intended purpose, and is preferably 10% by mass or greater but 60% by mass or less and more preferably 20% by mass or greater but 60% by mass or less in terms of a drying property of the processing fluid and discharging reliability of the processing fluid when the processing fluid is applied to an inkjet method.

<Other Components>

Examples of the other components in the processing fluid include, but are not limited to, a defoaming agent, a preservative and a fungicide, a corrosion inhibitor, and a pH regulator.

—Defoaming Agent—

The defoaming agent has no particular limit. For example, silicone-based defoaming agents, polyether-based defoaming agents, and aliphatic acid ester-based defoaming agents are suitable. These can be used alone or in combination. Of these, silicone-based defoaming agents are preferable to easily break foams.

—Preservatives and Fungicides—

The preservatives and fungicides are not particularly limited. A specific example is 1,2-benzisothiazolin-3-on.

—Corrosion Inhibitor—

The corrosion inhibitor has no particular limit. Examples thereof are acid sulfite and sodium thiosulfate.

—pH Regulator—

The pH regulator has no particular limit. Specific examples thereof include, but are not limited to, amines such as diethanol amine and triethanol amine. The pH of the processing fluid is preferably from 7 through 12 and more preferably from 8 through 11 in terms of preventing corrosion of a metallic member that may contact the processing fluid.

It is possible to produce the processing fluid by mixing the water, the flocculant, the urethane resin, the organic solvent, and the surfactant, and the other components as needed, and stirring and mixing the resultant as needed. Stirring and mixing can be performed with, for example, a stirrer using an ordinary stirring blade, a magnetic stirrer, and a high-speed disperser.

—Physical Properties of Processing Fluid—

The physical properties of the processing fluid are not particularly limited and may be appropriately selected depending on the intended purpose. For example, the following ranges of the viscosity and the pH of the processing fluid are preferable.

The viscosity of the processing fluid at 25 degrees C. is preferably 5 mPa·s or higher but 20 mPa-s or lower and more preferably 5 mPa·s or higher but 15 mPa-s or lower because a good dischargeability of the processing fluid can be obtained.

The viscosity can be measured by, for example, a rotary viscometer (RE-80L, manufactured by TOKI SANGYO CO., LTD.). The measuring conditions are as follows:
Standard cone rotor (1° 34′×R24)
Sample liquid amount: 1.2 mL
Number of rotations: 50 rotations per minute (rpm)
−25 degrees C.
Measuring time: three minutes

The pH of the processing fluid is preferably from 7 through 12 and more preferably from 8 through 11 in terms of preventing corrosion of a metallic member that may contact the processing fluid.

(Set of Processing Fluid and Ink)

A set of a processing fluid and an ink of the present disclosure includes the processing fluid of the present disclosure and an ink containing a coloring material, a resin, and water.

Using the set of the processing fluid and the ink of the present disclosure, it is possible to obtain a printed matter excellent in scratch resistance through repeated scratching.

<Ink>

An ink used in the present disclosure is preferably a water-based ink for mainly inkjet systems.

The ink contains a coloring material, a resin, and water, and further contains other components as needed.

—Coloring Material—

The coloring material has no particular limit. For example, pigments and dyes are suitable.

The pigment includes inorganic pigments and organic pigments. These can be used alone or in combination. In addition, it is possible to use a mixed crystal.

As the pigments, for example, black pigments, yellow pigments, magenta pigments, cyan pigments, white pigments, green pigments, orange pigments, gloss pigments of gold, silver, etc., and metallic pigments can be used.

As the inorganic pigments, in addition to titanium oxide, iron oxide, calcium carbonate, barium sulfate, aluminum hydroxide, barium yellow, cadmium red, and chrome yellow, carbon black manufactured by known methods such as contact methods, furnace methods, and thermal methods can be used.

As the organic pigments, it is possible to use azo pigments, polycyclic pigments (phthalocyanine pigments, perylene pigments, perinone pigments, anthraquinone pigments, quinacridone pigments, dioxazine pigments, indigo pigments, thioindigo pigments, isoindolinone pigments, and quinophthalone pigments, etc.), dye chelates (basic dye type chelates, acid dye type chelates, etc.), nitro pigments, nitroso pigments, and aniline black. Of these pigments, pigments having good affinity with solvents are preferable. Also, hollow resin particles and inorganic hollow particles can be used.

Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1). Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51; C.I. Pigment Red 1, 2, 3, 5, 17, 22, 23, 31, 38, 48:2, 48:2 (Permanent Red 2B(Ca)), 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4 (Phthalocyanine Blue), 16, 17:1, 56, 60, and 63: and C.I. Pigment Green 1, 4, 7, 8, 10, 17, 18, and 36.

The type of dye is not particularly limited, may be appropriately selected depending on the intended purpose, and includes, for example, acidic dyes, direct dyes, reactive dyes, and basic dyes. These can be used alone or in combination.

Specific examples of the dye include, but are not limited to, C.I. Acid Yellow 17, 23, 42, 44, 79, and 142, C.I. Acid Red 52, 80, 82, 249, 254, and 289, C.I. Acid Blue 9, 45, and 249. C.I. Acid Black 1, 2, 24, and 94, C. I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The proportion of the coloring material in ink is preferably from 0.1 to 15 percent by mass and more preferably from 1 to 10 percent by mass relative to the total amount of the ink in terms of enhancement of image density, fixability, and discharging stability.

The pigment is dispersed in the ink by, for example, preparing a self-dispersible pigment by introducing a hydrophilic functional group into the pigment, coating the surface of the pigment with resin, or using a dispersant.

To prepare a self-dispersible pigment by introducing a hydrophilic functional group into a pigment, for example, it is possible to add a functional group such as sulfone group and carboxyl group to the pigment (e.g., carbon) to disperse the pigment in water.

To coat the surface of the pigment with resin, the pigment is encapsulated by microcapsules to make the pigment dispersible in water. This can be referred to as a resin-coated pigment. In this case, the pigment to be added to ink is not necessarily wholly coated with resin. Pigments partially or wholly uncovered with resin may be dispersed in the ink unless the pigments have an adverse impact.

To use a dispersant, for example, a known dispersant of a small molecular weight type or a high molecular weight type represented by a surfactant is used to disperse the pigments in ink.

As the dispersant, it is possible to use, for example, anionic surfactants, cationic surfactants, nonionic surfactants, amphoteric surfactants, etc. depending on the pigments. Also, a nonionic surfactant (RT-100, manufactured by TAKEMOTO OIL & FAT CO., LTD.) and a formalin condensate of naphthalene sodium sulfonate are suitable as dispersants.

These dispersants can be used alone or in combination.

<Pigment Dispersion>

The ink can be obtained by mixing a coloring material with materials such as water and organic solvent. It is also possible to mix a pigment with water, a dispersant, etc., first to prepare a pigment dispersion and thereafter mix the pigment dispersion with materials such as water and organic solvent to manufacture ink.

The pigment dispersion is obtained by dispersing water, pigment, pigment dispersant, and other optional components and adjusting the particle size. It is good to use a dispersing device for dispersion.

The particle diameter of the pigment in the pigment dispersion has no particular limit and may be appropriately selected depending on the intended purpose. For example, the maximum frequency in the maximum number conversion is preferably from 20 to 500 nm and more preferably from 20 to 150 nm to improve dispersion stability of the pigment and ameliorate the discharging stability and image quality such as image density. The particle diameter of the pigment can be measured using a particle size analyzer (Nanotrac Wave-UT151, manufactured by MicrotracBEL Corp).

In addition, the proportion of the pigment in the pigment dispersion is not particularly limited and can be suitably selected to suit a particular application. In terms of improving discharging stability and image density, the content is preferably from 0.1 to 50 percent by mass and more preferably from 0.1 to 30 percent by mass.

During the production, coarse particles are optionally filtered off from the pigment dispersion with a filter, a centrifuge, etc. preferably followed by degassing.

<Resin>

Examples of the resin include, but are not limited to, urethane resins and acrylic resins.

As the resin, resin particles may be dispersed in water serving as a dispersion medium to obtain a resin emulsion. The obtained resin emulsion may be mixed with materials such as the coloring material and an organic solvent. In this way, the ink can be obtained. As the resin particles, an appropriately synthesized product may be used or a commercially available product may be used.

As the urethane resins, polycarbonate urethane resins are preferable in terms of a high scratch resistance and fixability. Examples of the polycarbonate urethane resins include, but are not limited to, TAKELAC WS-4000, W-6010, and W-6110 available from Mitsui Chemicals, Inc.; and UCOAT SERIES available from DKS Co., Ltd.

Examples of the acrylic resins include, but are not limited to, acrylic resins, vinyl acetate resins, styrene-butadiene resins, vinyl chloride resins, acrylic-styrene resins, butadiene resins, and styrene resins. These resins are preferably polymers containing both of a hydrophilic moiety and a hydrophobic moiety.

Examples of commercially available resin emulsions include, but are not limited to, MICROGEL E-1002 and E-5002 (styrene-acrylic resin emulsion, available from Nippon Paint Co., Ltd.), BONCOAT 4001 (acrylic-based resin emulsion, available from DIC Corporation), BONCOAT 5454 (styrene-acrylic-based resin emulsion, available from DIC Corporation), SAE-1014 (styrene-acrylic-based resin emulsion, available from Zeon Corporation), and SAlVINOL SK-200 (acrylic-based resin emulsion, available from Saiden Chemical Industry Co., Ltd.).

The volume average particle diameter of the resin particles is not particularly limited, may be appropriately selected depending on the intended purpose, and is preferably 10 nm or greater but 1,000 nm or less, more preferably 10 nm or greater but 200 nm or less, and particularly preferably 10 nm or greater but 100 nm or less.

The content of the resin is not particularly limited, may be appropriately selected depending on the intended purpose, and is preferably 1% by mass or greater but 30% by mass or less and more preferably 5% by mass or greater but 20% by mass or less relative to the total amount of the ink in terms of a high scratch resistance and fixability.

<Water>

As the water, pure water such as ion-exchanged water, ultrafiltrated water, reverse osmotic water, and distilled water, and ultrapure water can be used.

The content of the water in the ink is not particularly limited, may be appropriately selected depending on the intended purpose, and is preferably 10% by mass or greater but 90% by mass or less and more preferably 20% by mass or greater but 60% by mass or less in terms of a drying property and discharging reliability of the ink.

<Additives>

The ink may contain, for example, a surfactant, a defoaming agent, a preservative and a fungicide, a corrosion inhibitor, and a pH regulator as needed.

The same components as those in the processing fluid can be used as the surfactant, the defoaming agent, the preservative and the fungicide, the corrosion inhibitor, and the pH regulator.

The property of the ink is not particularly limited and can be suitably selected to suit to a particular application. For example, viscosity, surface tension, pH, etc., are preferably in the following ranges.

The viscosity of the ink at 25 degrees C. is preferably from 5 to 30 mPa-s and more preferably from 5 to 25 mPa·s to improve print density and text quality and obtain good dischargeability. The viscosity can be measured by, for example, a rotatory viscometer (RE-80L, manufactured by TOKI SANGYO CO., LTD.). The measuring conditions are as follows:
Standard cone rotor (1° 34′×R24)
Sample liquid amount: 1.2 mL
Number of rotations: 50 rotations per minute (rpm)
−25 degrees C.
Measuring time: three minutes

The surface tension of the ink is preferably 35 mN/m or less and more preferably 32 mN/m or less at 25 degrees C. in terms that the ink is suitably levelized on a print medium and the drying time of the ink is shortened. The pH of the ink is preferably from 7 to 12 and more preferably from 8 to 11 in terms of prevention of corrosion of metal materials contacting the ink.

<Print Medium>

The print medium for use in the present disclosure is not particularly limited and may be appropriately selected depending on the intended purpose. For example, plain paper, gloss paper, special paper, cloth, films, OHP sheets, general-purpose print paper, and cardboard bae paper (liners) are usable. Also, anon-permeating substrate is particularly suitable for use.

The non-permeating substrate has a surface with any or all of low moisture permeability, absorbency, and adsorptivity, and includes a material having myriad of hollow spaces inside but not open to the outside.

To be more quantitative, the substrate has a water-absorption amount of 10 mL/m² or less between the contact and 30 msec^{1/2} after the contact according to Bristow method.

Among the non-permeating substrates, resin films are preferable. As the resin films, polypropylene films, polyethylene terephthalate films, and nylon films are more preferable because a good adhesiveness is obtained.

Examples of the polypropylene films include, but are not limited to, P-2002, P-2102, P-2161, and P-4166 available from Toyobo Co., Ltd.; PA-20, PA-30, and PA-20W available from SUNTOX Co., Ltd.; and FOA, FOS, and FOR available from Futamura Chemical Co., Ltd.

Examples of the polyethylene terephthalate films include, but are not limited to, E-5100 and E-5102 available from Toyobo Co., Ltd.; P60 and P375 available from Toray Industries, Inc.; and G2, G2P2, K, and SL available from Teijin DuPont Film Co., Ltd.

Examples of the nylon films include, but are not limited to, HARDEN FILM N-1100, N-1102, and N-1200 available from Toyobo Co., Ltd.: and ON, NX, MS, and NK available from Unitika Ltd.

(Printing Method and Printing Apparatus)

A printing method of the present disclosure includes a processing fluid applying step and an ink applying step, and further includes other steps as needed.

A printing apparatus of the present disclosure includes a processing fluid applying unit and an ink applying unit, and further includes other units as needed.

<Processing Fluid Applying Step and Processing Fluid Applying Unit>

The processing fluid applying step is a step of applying the processing fluid included in the set of the processing fluid and the ink of the present disclosure to a print medium, and is performed by the processing fluid applying unit.

For application of the processing fluid, corona treatment by a conductive roller or plasma may be applied to the surface of a print medium, if the print medium is a non-permeating substrate such as PET Generally, corona treatment improves hydrophilicity of an organic material, and improves wettability and coating uniformity of a water-based liquid.

The method for applying the processing fluid is not particularly limited and may be appropriately selected depending on the intended purpose. Examples of the method include, but are not limited to, an inkjet method, a blade coating method, a gravure coating method, a gravure offset coating method, a bar coating method, a roll coating method, a spray coating method, a knife coating method, an air knife coating method, a comma coating method, a U-comma coating method, an AKKU coating method, a smoothing coating method, a microgravure coating method, a reverse roll coating method, a four-roll coating method, a five-roll coating method, a dip coating method, a curtain coating method, a slide coating method, and a die coating method. Among these methods, a roll coating method and a spray coating method are preferable.

A print medium to which the processing fluid is applied may be, as needed, subjected to a heating step of heating the print medium and drying the processing fluid. However, the heating step may be skipped. The heating step is a step of heating the print medium with a known heating unit such as a roll heater, a drum heater, and hot air and drying the processing fluid applied to the print medium.

<Ink Applying Step and Ink Applying Unit>

The ink applying step is a step of applying the ink included in the set of the processing fluid and the ink of the present disclosure, and is performed by the ink applying unit.

In the present disclosure, the ink is applied to the print medium after the processing fluid is applied to the print medium. The ink may be applied before or after the processing fluid is dried.

The method for applying the ink is not particularly limited. Examples of the method include, but are not limited to, an inkjet method, a blade coating method, a gravure coating method, a gravure offset coating method, a bar coating method, a roll coating method, a knife coating method, an air knife coating method, a comma coating method, a U-comma coating method, an AKKU coating method, a smoothing coating method, a microgravure coating method, a reverse roll coating method, a four-roll coating method, a five-roll coating method, a dip coating method, a curtain coating method, a slide coating method, and a die coating method. Among these methods, an inkjet method is preferable because of a high device maintainability and a high operation efficiency.

It is preferable to provide the heating step after the ink applying step.

In the heating step, a heating process at 60 degrees C. or higher but 80 degrees C. or lower is preferable in terms of obtaining a sufficient drying effect and preventing damages on the print medium.

The heating time is preferably 10 seconds or longer but 10 minutes or shorter and more preferably 1 minute or longer but 2 minutes or shorter in terms of obtaining a sufficient drying effect and preventing damages on the print medium.

The drawing is a schematic view illustrating an example of the printing apparatus of the present disclosure used in the printing method of the present disclosure.

A printing apparatus 101 includes a plurality of head units 110K, 110C, 110M, and 110Y that serve as an example of the ink applying unit and in which heads for discharging inks are integrated, a plurality of maintenance units 111K, 111C, 111M, and 111Y corresponding to the head units respectively and configured to maintain the heads, a plurality of ink cartridges 107K, 107C, 107M, and 107Y serving as an example of an ink housing unit and configured to store and supply inks, and a plurality of sub-ink tanks 108K, 108C, 108M, and 108Y configured to store part of the inks supplied from the ink cartridges and supply the inks to the heads at appropriate pressures.

The printing apparatus 101 includes a conveyor belt 113 configured to convey a print medium 114 by adsorption of the print medium 114 with a suction fan 120, conveyor rollers 119 and 121 supporting the conveyor belt 113, a tension roller 115 configured to control the conveyor belt 113 to keep an appropriate tension, a platen 124 and a platen roller 118 configured to maintain an appropriate flatness of the conveyor belt 113, a charging roller 116 configured to apply electrostatic charging for adsorption of the print medium 114, a paper ejection mechanism including: a paper ejection roller 117 configured to press the print medium 114; and a paper ejection tray 104 on which the print medium 114 is stocked, a paper feeding tray 103 on which print media 114 are stocked, separating pads 112 and 122 configured to send out the print media 114 one by one from the paper feeding tray, a counter roller 123 configured to adsorb a print medium 114 sent thereto to a charging belt without fail, and a manual paper feeding tray 105 used when feeding a print medium manually.

The printing apparatus 101 further includes a waste liquid tank 109 configured to collect a waste liquid discharged after maintenance, and an operation panel 106 from which it is possible to operate the apparatus and which is capable of displaying the status of the apparatus.

The nozzle lines of the head units 110K, 110C, 110M, and 110Y are arranged orthogonally to the conveying direction of the print medium 114, and have a length longer than or equal to the recording region.

One print medium 114 is separated from the paper feeding tray by the separating roller, and closely attached to the conveyor belt by a pressing roller and thereby secured to the conveyor belt. When the print medium 114 passes below the head units, liquid droplets are discharged to the print medium 114 and an image, which is an aggregation of dots formed by the liquid droplets, is formed over the print medium 114. The print medium 114 is then separated from the conveyor belt by a separation claw, and supported by the paper ejection rollers and ejected onto the paper ejection tray.

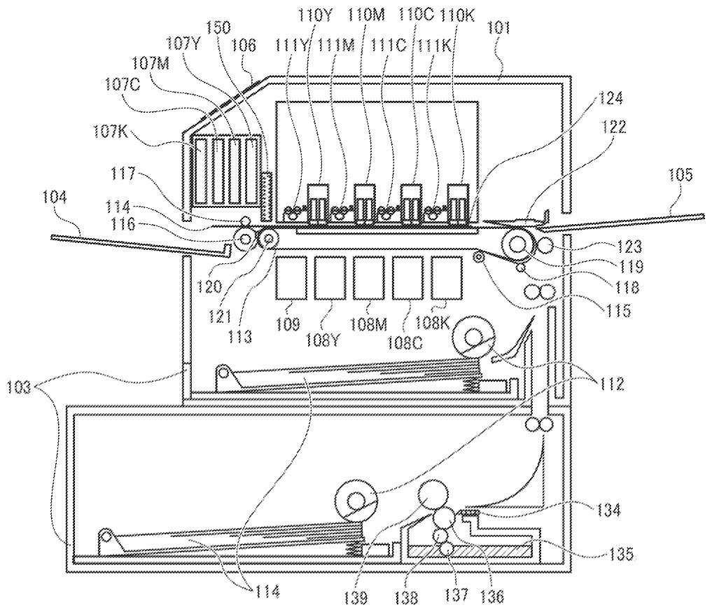

The printing apparatus 101 illustrated in FIG. 1 also includes an applying mechanism as a mechanism configured to process the surface of a print medium with a processing fluid, and employs a roller applying mechanism. The processing fluid is stored in a processing fluid storing tank 135 serving as an example of a processing fluid housing unit. A pumping roller 137 pumps up the processing fluid onto the surface of the roller, and transfers the processing fluid to a film thickness controlling roller 138. Then, the processing fluid is transferred to an applying roller 136 serving as an example of the processing fluid applying unit, and then transferred and applied to a print medium 114 inserted between the applying roller 136 and a counter roller 139 for application.

The amount of the processing fluid to be applied, transferred to the applying roller 136, is adjusted by control of the nip gap from the applying roller 136. When it is not desired to apply the processing fluid, a movable blade 134 may be pressed against the applying roller 136 to scrape away the processing fluid over the surface of the applying roller in a manner that no processing fluid remains over the applying roller 136. This makes it possible to previously prevent drying-induced thickening of the processing fluid remaining over the applying roller 136, and functional disorders such as adhesion with the counter roller 139 for application and coating unevenness.

As illustrated in FIG. 1, two paper feeding units may be provided one above the other, in order that the lower paper feeding unit is used when applying the processing fluid and the upper paper feeding unit is used when not applying the processing fluid.

Instead of the roller application described above, it is also possible to apply the processing fluid by spraying by a discharging method. For example, ahead like the head unit 110K may be filled with the processing fluid and the processing fluid may be discharged to the print medium 114 like an ink. This makes it possible to control the amount of the processing fluid to be discharged and the position to which the processing fluid is discharged highly accurately and easily. The roller application method and the spray application method may be used in combination.

Whatever method is used, it is possible to apply the processing fluid to an arbitrary position in an arbitrary amount.

The print medium to which the processing fluid and inks are attached may be heated with a hot air sending fan 150. This can promote drying and improve fixability. In the present embodiment, the print medium is heated with a hot air fan after printing. However, the print medium may be heated before or after image formation. The heating method is not limited to the hot air fan, but may be performed with such a unit as a heating roller.

Moreover, image forming, recording, printing, etc. in the present disclosure represent the same meaning.

Print media and media represent the same meaning.

### EXAMPLES

The present disclosure will be described below by way of Examples. The present disclosure should not be construed as being limited to these Examples. Unless otherwise particularly specified, for example, preparations and evaluations in Examples and Comparative Examples were performed at 25 degrees C. at a relative humidity of 60%.

(Pigment Dispersion Preparation Example 1)

<Preparation of Dispersant-Dispersed Black Pigment Dispersion>

A mixture in which carbon black (BLACK PEARLS 1000 obtained from Cabot corporation) (100 g), a sodium naphthalene sulfonate formalin condensate (PIONINE A-45-PN, obtained from Takemoto Yushi Co., Ltd.) (15 g), and ion-exchanged water (280 g) were mixed was pre-mixed, and then subjected to dispersion treatment for 30 minutes using DYNOMILL (obtained from Shinmaru Enterprises Corporation) with zirconia beads having a diameter of 0.3 mm at a rotation speed of 10 m/sec at a liquid temperature of 10 degrees C., to obtain a pigment dispersion.

Next, the obtained pigment dispersion was separated from the zirconia beads, and filtrated through a membrane filter (cellulose acetate type) having an average pore diameter of 0.8 micrometers. Subsequently, the water content in the resultant was adjusted in a manner that the solid concentration would be 20% by mass, to obtain a dispersant-dispersed black pigment dispersion.

(Pigment Dispersion Preparation Example 2)

<Preparation of Dispersant-Dispersed Magenta Pigment Dispersion>

A mixture having the composition described below was pre-mixed and then subjected to dispersion treatment for 30 minutes using DYNOMILL (obtained from Shinmaru Enterprises Corporation) with zirconia beads having a diameter of 0.3 mm at a rotation speed of 10 m/sec at a liquid temperature of 10 degrees C., to obtain a pigment dispersion.

Next, the obtained pigment dispersion was separated from the zirconia beads, and filtrated through a membrane filter (cellulose acetate type) having an average pore diameter of 0.8 micrometers. Subsequently, the water content in the resultant was adjusted in a manner that the solid concentration would be 20% by mass, to obtain a dispersant-dispersed magenta pigment dispersion.

[Composition]
C.I. Pigment Red 122: 15 parts by mass
Anionic surfactant (PIONINE A-51-B, obtained from Takemoto Yushi Co., Ltd.): 2 parts by mass
Ion-exchanged water: 83 parts by mass

(Pigment Dispersion Preparation Example 3)

<Preparation of Dispersant-Dispersed Cyan Pigment Dispersion>

A mixture having the composition described below was pre-mixed and then subjected to dispersion treatment for 30 minutes using DYNOMILL (obtained from Shinmaru Enterprises Corporation) with zirconia beads having a diameter of 0.3 mm at a rotation speed of 10 m/sec at a liquid temperature of 10 degrees C., to obtain a pigment dispersion.

Next, the obtained pigment dispersion was separated from the zirconia beads, and filtrated through a membrane filter (cellulose acetate type) having an average pore diameter of 0.8 micrometers. Subsequently, the water content in the resultant was adjusted in a manner that the solid concentration would be 20% by mass, to obtain a dispersant-dispersed cyan pigment dispersion.

[Composition]
Copper phthalocyanine pigment: 15 parts by mass
Anionic surfactant (PIONINE A-51-B, obtained from Takemoto Yushi Co., Ltd.): 2 parts by mass
Ion-exchanged water: 83 parts by mass

(Pigment Dispersion Preparation Example 4)

<Preparation of Dispersant-Dispersed Yellow Pigment Dispersion>

A mixture having the composition described below was pre-mixed and then subjected to dispersion treatment for 30 minutes using DYNOMILL (obtained from Shinmaru Enterprises Corporation) with zirconia beads having a diameter of 0.3 mm at a rotation speed of 10 m/sec at a liquid temperature of 10 degrees C., to obtain a pigment dispersion.

Next, the obtained pigment dispersion was separated from the zirconia beads, and filtrated through a membrane filter (cellulose acetate type) having an average pore diameter of 0.8 micrometers. Subsequently, the water content in the resultant was adjusted in a manner that the solid concentration would be 20% by mass, to obtain a dispersant-dispersed yellow pigment dispersion.

[Composition]
C.I. Pigment Yellow 74: 15 parts by mass
Anionic surfactant (PIONINE A-51-B, obtained from Takemoto Yushi Co., Ltd.): 2 parts by mass
Ion-exchanged water: 83 parts by mass

(Ink Preparation Example 1)

—Preparation of Black Ink 1—

The ink prescription described below was mixed, stirred sufficiently with a disperser, and subsequently filtrated through a membrane filter (cellulose acetate type) having an average pore diameter of 0.8 micrometers, to obtain a black ink 1.

[Ink Prescription]
2-Butanediol: 30.0 parts by mass
SURFYNOL 440 (an acetylene glycol surfactant, obtained from Nissin Chemical Co., Ltd.): 0.5 parts by mass
Dispersant-dispersed black pigment dispersion of Preparation example 1: 20.0 parts by mass
TAKELAC W-6110 (obtained from Mitsui Chemicals, Inc., a polycarbonate urethane resin): 20.0 parts by mass
Pure water: 29.5 parts by mass

(Ink Preparation Example 2)

—Preparation of Magenta Ink 1—

A magenta ink 1 was obtained in the same manner as in Ink preparation example 1, except that unlike in Ink preparation example 1, the black pigment dispersion of Pigment dispersion preparation example 1 was changed to the magenta pigment dispersion of Pigment dispersion preparation example 2.

(Ink Preparation Example 3)

—Preparation of Cyan Ink 1—

A cyan ink 1 was obtained in the same manner as in Ink preparation example 1, except that unlike in Ink preparation example 1, the black pigment dispersion of Pigment dispersion preparation example 1 was changed to the cyan pigment dispersion of Pigment dispersion preparation example 3.

(Ink Preparation Example 4)

—Preparation of Yellow Ink 1—

A yellow ink 1 was obtained in the same manner as in Ink preparation example 1, except that unlike in Ink preparation example 1, the black pigment dispersion of Pigment dispersion preparation example 1 was changed to the yellow pigment dispersion of Pigment dispersion preparation example 4.

### Examples 1 to 14 and Comparative Examples 1 to 5

<Preparation of Processing Fluid>

The processing fluid prescriptions presented in Table 1 to Table 4 below were mixed, sufficiently stirred, and subsequently filtrated through a filter, to prepare processing fluids of Examples 1 to 14 and Comparative Examples 1 to 5.

TABLE 1

| | | Ex. | | | | |
|---|---|---|---|---|---|---|
| | | 1 | 2 | 3 | 4 | 5 |
| Pre-processing fluid No. | | 1 | 2 | 3 | 4 | 5 |
| Organic | 1,2-Propanediol | | | | 20.0 | |
| solvent | 1,2-Butanediol | | | | | |
| | 1,3-Butanediol | 20.0 | | | | |
| | 3-Methoxy-3-methylbutanol | | | | | |
| | 1,2Hexanediol | | | | | |
| | 1,3-Propanediol | 20.0 | 20.0 | 20.0 | | |
| Surfactant | SUREYNOL 440 | | | | | |
| | SURFYNOL PSA-336 | | | 0.5 | 0.5 | 0.5 |
| | TEGO WET 270 | 0.5 | 0.5 | | | |
| Resin | TAKELAC WS-6021 | 10.0 | | 10.0 | 10.0 | 10.0 |
| | TAKELAC W-6061 | | | | | |
| | SUPERFLEX 470 | | 10.0 | | | |
| | TAKELAC W-5030 | | | | | |
| | BONCOAT 400 | | | | | |
| Flocculant | Calcium acetate | 3.0 | 3.0 | 3.0 | | |
| | Magnesium sulfate | | | | 3.0 | 3.0 |
| Water | Pure water | Balance | Balance | Balance | Balance | Balance |

| | | | | | |
|---|---|---|---|---|---|
| Total (% by mass) | 100 | 100 | 100 | 100 | 100 |

TABLE 2

| | | Ex. | | | | | |
|---|---|---|---|---|---|---|---|
| | | 6 | 7 | 8 | 9 | 10 | 11 |
| Pre-processing fluid No. | | 6 | 7 | 8 | 9 | 10 | 11 |
| Organic | 1,2-Propanediol | | | | 20.0 | 20.0 | 20.0 |
| solvent | 1,2-Butanediol | 10.0 | | | | | |
| | 1,3-Butanediol | | | 10.0 | | | |
| | 2 3-Butanediol | | | 10.0 | | | |
| | 3-Methoxy-3-methythutanol | 10. 0 | | | | | |
| | 1,2-Hexanediol | | 10.0 | | | | |
| | 1,3-Propanediol | | | | | | |
| Surfactant | SURFYNOL 440 | | | | | 0.5 | |
| | SURFYNOL PSA-336 | 0.5 | 0.5 | 0.5 | 0.5 | | 0.5 |
| | TEGO WET 270 | | | | | | |
| Resin | TAKELAC WS-6021 | 10.0 | 10.0 | 10.0 | 8.0 | 10.0 | 12.0 |
| | TAKELAC W-6061 | | | | | | |
| | SUPERFLEX 470 | | | | | | |
| | TAKELAC W-5030 | | | | | | |
| | BONCOAT 400 | | | | 2.0 | | |
| Flocculant | Calcium acetate | | | | | | |
| | Magnesium sulfate | 3.0 | 3.0 | 3.0 | 3.0 | 3.0 | 3.0 |
| Water | Pure water | Balance | Balance | Balance | Balance | Balance | Balance |

| | | | | | | |
|---|---|---|---|---|---|---|
| Total (% by mass) | 100 | 100 | 100 | 100 | 100 | 100 |

TABLE 3

| | | Ex. | | |
|---|---|---|---|---|
| | | 12 | 13 | 14 |
| Pre-processing fluid No. | | 6 | 6 | 6 |
| Organic | 1,2-Propanediol | | | |
| solvent | 1,2-Butanediol | 10.0 | 10.0 | 10.0 |
| | 1,3-Butanediol | | | |
| | 2,3-Butanediol | | | |
| | 3-Methoxy-3-methylbutanol | 10.0 | 10.0 | 10.0 |
| | 1,2-Elexanediol | | | |
| | 1,3-Propanediol | | | |
| Surfactant | SURFYNOL 440 | | | |
| | SURFYNOL PSA-336 | 0.5 | 0.5 | 0.5 |
| | TEGO WET 270 | | | |
| Resin | TAKELAC WS-6021 | 10.0 | 10.0 | 10.0 |
| | TAKELAC W-6061 | | | |
| | SUPERFLEX 470 | | | |
| | TAKELAC W-5030 | | | |
| | BONCOAT 400 | | | |
| Flocculant | Calcium acetate | | | |
| | Magnesium sulfate | 3.0 | 3.0 | 3.0 |
| Water | Pure water | Balance | Balance | Balance |

| | | | |
|---|---|---|---|
| Total (% by mass) | 100 | 100 | 100 |

TABLE 4

| | | Comp. Ex. | | | | |
|---|---|---|---|---|---|---|
| | | 1 | 2 | 3 | 4 | 5 |
| Pre-processing fluid No. | | 12 | 13 | 13 | 13 | 13 |
| Organic | 1,2-Propanediol | 20.0 | 20.0 | 20.0 | 20.0 | 20.0 |
| solvent | 1,2-Butanediol | | | | | |
| | 1,3-Butanediol | | | | | |
| | 2,3-Butanediol | | | | | |
| | 3-Methoxy-3-methylbutanol | | | | | |
| | 1,2-Hexanediol | | | | | |
| | 1,3-Propanediol | | | | | |
| Surfactant | SURFYNOL 440 | 0.5 | 0.5 | 0.5 | 0.5 | 0.5 |
| | SURFYNOL PSA-336 | | | | | |
| | TEGO WET 270 | | | | | |
| Resin | TAKELAC WS-6021 | | | | | |
| | TAKELAC W-6061 | 10.0 | | | | |
| | SUPERFLEX 470 | | | | | |
| | TAKELAC W-5030 | | 10.0 | 10.0 | 10.0 | 10.0 |
| | BONCOAT 400 | | | | | |
| Flocculant | Calcium acetate | | | | | |
| | Magnesium sulfate | 3.0 | 3.0 | 3.0 | 3.0 | 3.0 |
| Water | Pure water | Balance | Balance | Balance | Balance | Balance |

| | | | | | |
|---|---|---|---|---|---|
| Total (% by mass) | 100 | 100 | 100 | 100 | 100 |

The details of the components described in Table 1 to Table 4 are as follows.

—Surfactant—
SURFYNOL 440: an acetylene glycol surfactant, obtained from Nissin Chemical Co. Ltd.
SURFYNOL PSA-336: an acetylene glycol surfactant, obtained from Nissin Chemical Co. Ltd.
TEGO WET 270: a polyether-modified siloxane compound, obtained from Evonik Industries AG

—Resin—
TAKELAC WS-6021: a polycarbonate urethane resin, with a solid concentration of 30.0% by mass, obtained from Mitsui Chemicals, Inc., with a breaking elongation of 750% and a breaking strength of 50 MPa
TAKELAC W-6061: a polycarbonate urethane resin, with a solid concentration of 30.0% by mass, obtained from Mitsui Chemicals. Inc., with a breaking elongation of 1,000% and a breaking strength of 10 MPa
SUPERFLEX 470: a polycarbonate urethane resin, with a solid concentration of 38.0% by mass, obtained from DKS. Co., Ltd., with a breaking elongation of 640% and a breaking strength of 40 MPa
TAKELAC W-5030: a polycarbonate urethane resin, with a solid concentration of 30.0% by mass, obtained from Mitsui Chemicals, Inc., with a breaking elongation of 480% and a breaking strength of 34 MPa
BONCOAT 400; an acrylic resin, with a solid concentration of 38.0% by mass, obtained from DIC Corporation

The tensile strength and the breaking elongation of the urethane resins were measured in the manner described below.

The urethane resin emulsion was applied over a polytetrafluoroethylene (PTFE) sheet, and dried at 40 degrees C. for 12 hours and further dried at 60 degrees C. for 6 hours. Subsequently, the urethane resin film was peeled, to produce a urethane resin film having an average thickness of 500 micrometers.

The obtained urethane resin film was drawn at a tensile speed of 200 mm/min with a tensile tester (obtained from Shimadzu Corporation, AUTOGRAPH AGS-5KN) at a measuring temperature of 25 degrees C. The strength and the elongation when the urethane resin film was broken were measured.

—Flocculant—
Calcium acetate (obtained from Daito Chemical Co., Ltd., product name: CAL FRESH)
Magnesium sulfate (obtained from Naikai Salt Industries Co. Ltd., product name: MAGNESIUM SULFATE)

Next, using the printing apparatus illustrated in FIG. 1, each processing fluid (10 g/mm²) was applied to a K5 liner for cardboard (obtained from Oji Materia Co., Ltd.) with the roller applying mechanism, and then dried. Subsequently, using the black ink 1, the magenta ink 1, the cyan ink 1, and the yellow ink 1 described above, an image was formed thereon by an inkjet method.

Next, as regards each processing fluid and each image obtained, “tensile strength and breaking elongation of dry film formed of processing fluid”, “drying property of processing fluid”, “density unevenness”, “ink bleed”, an “scratch resistance” were evaluated in the manners described above. The results are presented in Table 5 to Table 8.

<Measurement of Tensile Strength and Breaking Elongation of Dry Film Formed of Processing Fluid>

Each processing fluid was applied over a polytetrafluoroethylene (PTFE) sheet with a roller, and dried at 40 degrees C. for 12 hours and further dried at 60 degrees C. for 6 hours. Subsequently, the dried film was peeled, to produce a dry film of the processing fluid having an average thickness of 500 micrometers.

The obtained dry film of the processing fluid was drawn at a tensile speed of 200 mm/min with a tensile tester (obtained from Shimadzu Corporation, AUTOGRAPH AGS-5KN) at a measuring temperature of 25 degrees C. The strength and the elongation when the dry film was broken were measured.

<Drying Property of Processing Fluid>

Using the printing apparatus illustrated in FIG. 1, each processing fluid (10 g/mm²) was applied to a K5 liner for cardboard (obtained from Oji Materia Co., Ltd.) with a roller. Immediately after application, the resultant was fed into an air oven at 70 degrees C. After fed into the air oven, the K5 liner for cardboard was taken out from the air oven once in every minute and the surface of the K5 liner was scratched with a finger, to evaluate the drying property of the processing fluid according to the evaluation criteria described below. B and A are practically usable levels.

[Evaluation Criteria]

A: The processing fluid was not attached to the finger even when the surface was scratched one minute after the K5 liner was fed into the air oven.

B: The processing fluid was attached to the finger when the surface was scratched one minute after the K5 liner was fed into the air oven, but was not attached to the finger two minutes after the feeding.

C: The processing fluid was attached to the finger when the surface was scratched two minutes after the K5 liner was fed into the air oven, but was not attached to the finger three minutes after the feeding.

D: The processing fluid was attached to the finger when the surface was scratched three minutes after the K5 liner was fed into the air oven, but was not attached to the finger four minutes after the feeding.

E: The processing fluid was attached to the finger even when the surface was scratched four minutes after the K5 liner was fed into the air oven.

<Density Unevenness>

The black ink 1, the magenta ink, the cyan ink 1, and the yellow ink 1 were filled in the printing apparatus illustrated in FIG. 1. Each processing fluid (10 g/mm²) was applied to a K5 liner for cardboard (obtained from Oji Materia Co., Ltd.) with a roller and dried. Subsequently, the black ink 1, the magenta ink, the cyan ink 1, and the yellow ink 1 were discharged to the region coated with the processing fluid to print solid square images having a size of 3 cm on each side at five positions. Then, the resultant was dried sufficiently in an air oven at 70 degrees C.

The obtained solid images were visually observed, to evaluate density unevenness according to the evaluation criteria described below. C. B, and A are practically usable levels.

[Evaluation Criteria]

A: No density unevenness was observed.

B: Slight density unevenness was observed but not problematic for practical use.

C: Density unevenness was observed but not problematic for practical use.

D: Obvious density unevenness was observed and problematic for practical use.

E: Severe density unevenness was observed and problematic for practical use.

<Ink Bleed>

The black ink 1, the magenta ink, the cyan ink 1, and the yellow ink 1 were filled in the printing apparatus illustrated in FIG. 1. Each processing fluid (10 g/mm²) was applied to a K5 liner for cardboard (obtained from Oji Materia Co., Ltd.) with a roller and dried. Subsequently, the black ink 1, the magenta ink, the cyan ink 1, and the yellow ink 1 were discharged to the region coated with the processing fluid to print letters of from 8 points to 24 points. Then, the resultant was dried sufficiently in an air oven at 70 degrees C.

The surrounding of each printed letter was visually observed to evaluate ink bleed according to the evaluation criteria described below. B and Aare practically usable levels.

[Evaluation Criteria]

A: No ink bleed was observed.

B: Slight ink bleed was observed but not problematic for practical use.

C: Ink bleed was observed but not problematic for practical use.

D: Obvious ink bleed was observed and problematic for practical use.

E: Severe ink bleed was observed and problematic for practical use.

<Scratch Resistance>

The processing fluid, the black ink 1, the magenta ink, the cyan ink 1, and the yellow ink 1 were filled in the printing apparatus illustrated in FIG. 1. Each processing fluid (10 g/mm²) was applied to a K5 liner for cardboard (obtained from Oji Materia Co., Ltd.) with a roller and dried. Subsequently, the black ink 1, the magenta ink, the cyan ink 1, and the yellow ink 1 were discharged to the region coated with the processing fluid to print a solid square image having a size of 3 cm on each side. Then, the resultant was dried sufficiently in an air oven at 70 degrees C.

Next, the solid image was scratched 50 times or more with a dry cotton cloth (shirting No. 3) under a load of 400 g. The solid image after scratched was visually observed, to evaluate scratch resistance according to the evaluation criteria described below. B and A are practically usable levels.

[Evaluation Criteria]

A: No scar was observed even when the solid image was scratched 50 times or more.

B: Slight scars were observed when the solid image was scratched 50 times, but not influential to image brightness and not problematic for practical use.

C: Scars were observed when the solid image was scratched 50 times, and slightly degraded image brightness and was problematic for practical use.

D: Scars were observed when the solid image was scratched 20 times or more but less than 50 times, and degraded image brightness and was problematic for practical use.

E: Scars were observed when the solid image was scratched less than 20 times, and degraded image brightness and was problematic for practical use.

TABLE 5

| | | Ex. | | | | |
|---|---|---|---|---|---|---|
| | | 1 | 2 | 3 | 4 | 5 |
| Processing fluid No. | | 1 | 2 | 3 | 4 | 5 |
| Ink No. | | Black ink 1 | | | | |
| Density unevenness | | C | C | C | A | A |
| Ink bleed | | B | B | A | A | A |
| Drying property of processing fluid | | B | B | B | B | B |
| Scratch resistance | | A | A | A | A | A |
| Dry film of | Tensile strength (MPa) | 3.8 | 3.7 | 3.8 | 3.8 | 3.8 |
| processing | Breaking elongation (%) | 100 | 90 | 100 | 100 | 100 |
| fluid | | | | | | |

TABLE 6

| | | Ex. | | | | | |
|---|---|---|---|---|---|---|---|
| | | 6 | 7 | 8 | 9 | 10 | 11 |
| Processing fluid No. | | 6 | 7 | 8 | 9 | 10 | 11 |
| Ink No. | | Black ink1 | | | | | |
| Density unevenness | | A | A | A | A | A | A |
| Ink bleed | | A | A | A | A | A | B |
| Drying property of | | B | B | B | A | B | B |
| processing fluid | | | | | | | |
| Scratch resistance | | A | A | A | B | A | A |
| Dry film of | Tensile | 3.8 | 3.8 | 3.8 | 3.6 | 3.8 | 4.0 |
| processing | strength (MPa) | | | | | | |
| fluid | Breaking | 100 | 100 | 100 | 90 | 100 | 110 |
| | elongation (%) | | | | | | |

TABLE 7

| | | Ex. | | |
|---|---|---|---|---|
| | | 12 | 13 | 14 |
| Processing fluid No. | | 6 | 6 | 6 |
| Ink No. | | Magenta | Cyan | Yellow |
| | | ink 1 | ink 1 | ink 1 |
| Density unevenness | | A | A | A |
| Ink bleed | | A | A | A |
| Drying property of processing fluid | | B | B | B |
| Scratch resistance | | A | A | A |
| Dry film of | Tensile strength (MPa.) | 3.8 | 3.8 | 3.8 |
| processing | Breaking elongation (%) | 100 | 100 | 100 |
| fluid | | | | |

TABLE 8

| | | Comp. Ex. | | | | |
|---|---|---|---|---|---|---|
| | | 1 | 2 | 3 | 4 | 5 |
| Processing fluid No. | | 12 | 13 | 13 | 13 | 13 |
| Ink No. | | Black | | Magenta | Cyan | Yellow |
| | | ink 1 | | ink 1 | ink 1 | ink 1 |
| Density unevenness | | B | B | B | B | B |
| Ink bleed | | A | A | A | A | A |
| Drying property of processing fluid | | B | B | B | B | B |
| Scratch resistance | | C | C | C | C | C |
| Dry film of | Tensile strength (MPa) | 1.6 | 1.2 | 1.2 | 1.2 | 1.2 |
| processing | Breaking elongation | 120 | 20 | 20 | 20 | 20 |
| fluid | (%) | | | | | |

Aspects and embodiments of the present disclosure are, for example, as follows.

<1> A processing fluid including:
water,
a flocculant, and
a urethane resin,
wherein a dry film formed of the processing fluid and having an average thickness of 500 micrometers has a tensile strength of 3.5 MPa or greater and a breaking elongation of 80% or greater.
   <2> The processing fluid according to <1>,
wherein the urethane resin includes a polycarbonate urethane resin.
   <3> The processing fluid according to <1> or <2>,
wherein the flocculant contains magnesium sulfate.
   <4> The processing fluid according to any one of <1> to <3>, further including
an organic solvent,
wherein the organic solvent is at least one selected from the group consisting of 1,2-propanediol, 1,2-butanediol, 1,3-butanediol, 2,3-butanediol, 3-methoxy-3-methylbutanol, and 1,2-hexanediol.
   <5> The processing fluid according to any one of <1> to <4>, further including
a surfactant,
wherein the surfactant includes an acetylene glycol surfactant.
   <6> The processing fluid according to any one of <1> to <5>, further including
an acrylic resin,
wherein a mass ratio of the acrylic resin: the urethane resin is from 1:9 through 9:1.
   <7> A set of a processing fluid and an ink, the set including:
the processing fluid according to any one of <1> to <6>; and
an ink containing a coloring material, a resin, and water.
   <8> The set according to <7>,
wherein the resin contained in the ink is a urethane resin.
   <9> A printing method including:
applying the processing fluid included in the set according to <7> or <8> to a print medium, and
applying the ink included in the set according to <7> or <8> to the print medium.
   <10> A printing apparatus including:
the set according to <7> or <8>;
a processing fluid applying unit configured to apply the processing fluid included in the set according to <7> or <8> to a print medium; and
an ink applying unit configured to apply the ink included in the set according to <7> or <8> to the print medium.

The processing fluid according to any one of <1> to <6>, the set according to <7> or <8>, the printing method according to <9>, and the printing apparatus according to <10> can solve the various problems in the related art and achieve the object of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A processing fluid comprising:
water;
a flocculant; and
a urethane resin,
wherein a dry film formed of the processing fluid and having an average thickness of 500 micrometers has a tensile strength of 3.5 MPa or greater and a breaking elongation of 80% or greater.

2. The processing fluid according to claim 1,
wherein the urethane resin comprises a polycarbonate urethane resin.

3. The processing fluid according to claim 1,
wherein the flocculant comprises magnesium sulfate.

4. The processing fluid according to claim 1, further comprising
an organic solvent,
wherein the organic solvent is at least one selected from the group consisting of 1,2-propanediol, 1,2-butanediol, 1,3-butanediol, 2,3-butanediol, 3-methoxy-3-methylbutanol, and 1,2-hexanediol.

5. The processing fluid according to claim 1, further comprising
a surfactant,
wherein the surfactant comprises an acetylene glycol surfactant.

6. The processing fluid according to claim 1, further comprising
an acrylic resin,
wherein a mass ratio of the acrylic resin: the urethane resin is from 1:9 through 9:1.

7. A set of a processing fluid and an ink, the set comprising:
the processing fluid according to claim 1; and
an ink containing a coloring material, a resin, and water.

8. The set according to claim 7,
wherein the resin contained in the ink is a urethane resin.

9. A printing method comprising:
applying the processing fluid included in the set according to claim 7 to a print medium; and
applying the ink included in the set according to claim 7 to the print medium.

10. A printing apparatus comprising:
the set according to claim 7;
a processing fluid applying unit configured to apply the processing fluid included in the set to a print medium; and
an ink applying unit configured to apply the ink included in the set to the print medium.
